(19) United States
(12) Patent Application Publication
(10) Pub. No.: US 2008/0017452 A1
(43) Pub. Date: Jan. 24, 2008

(54) LUBRICANT GUN

(76) Inventor: Li-Chi CHEN, Taichung Hsien (TW)

Correspondence Address: OSTROLENK FABER GERB & SOFFEN, 1180 AVENUE OF THE AMERICAS, NEW YORK, NY, 100368403, US

(21) Appl. No.: 11/537,703

(22) Filed: Oct. 2, 2006

(30) Foreign Application Priority Data
Jul. 5, 2006 (TW) 095124468

(51) Int. Cl. F16N 21/00

(52) U.S. Cl. 184/105.2

(57) ABSTRACT

A lubricant gun includes: a housing having a discharge spout and a longitudinal slide channel; a motor; a plunger disposed in the longitudinal slide channel to perform reciprocating movements; a power transmission unit driven by the motor to actuate the plunger, and including a crank connected to the plunger; a moving element movable along with the crank and the plunger to perform a cycle motion; a sensor mounted proximate to a moving path of the moving element to detect the moving element whenever the moving element moves past the sensor, and to generate a signal representative of a number of the cycle motions performed by the moving element; a processing unit connected to the sensor to produce information according to the signal generated by the sensor; and a display unit displaying the information produced by the processing unit.

### CROSS-REFERENCE TO RELATED APPLICATION

This application claims priority of Taiwanese application No. 095124468, filed on Jul. 5, 2006.

### BACKGROUND OF THE INVENTION

1. Field of the Invention

The invention relates to a lubricant gun, more particularly to a lubricant gun having a counting function.

2. Description of the Related Art

Referring to FIG. 1, a conventional lubricant gun 1 includes a lubricant transporting hose 101 and a mechanical type of counter 102 mounted on the lubricant transporting hose 101. The counter 102 includes a plurality of vanes (not shown) and a plurality of counting rollers 103 linked to the vanes. When lubricant is transported via the lubricant transporting hose 101, the lubricant will drive the vanes to rotate the counting rollers 103 so as to display the amount of the lubricant discharged via the lubricant transporting hose 101.

However, since the pressure for discharging the lubricant is significantly high, usually in a range from 6,000 to 10,000 psig, the components that constitute the counter 102 are liable to be abraded and eventually destroyed.

### SUMMARY OF THE INVENTION

Therefore, the object of the present invention is to provide a lubricant gun which can overcome the aforesaid shortcoming of the prior art.

The lubricant gun according to this invention includes a housing, a motor, a plunger, a power transmission unit, a moving element, a sensor, a processing unit, and a display unit. The housing includes a discharge spout, and a longitudinal slide channel fluidly communicating with the discharge spout. The motor is mounted within the housing. The plunger is disposed in the longitudinal slide channel to perform reciprocating movements, and has a pushing end extendable to the discharge spout. The power transmission unit is driven by the motor to actuate the plunger, and includes a crank connected to the plunger. The moving element is movable along with the crank and the plunger to perform a cycle motion. The sensor is mounted inside the housing proximate to a moving path of the moving element to detect the moving element whenever the moving element moves past the sensor, and to generate a signal representative of a number of the cycle motions performed by the moving element. The processing unit is connected to the sensor to produce information according to the signal generated by the sensor. The display unit is mounted on the housing and is connected to the processing unit to display the information produced by the processing unit.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional lubricant gun;

FIG. 2 is a schematic view of a first preferred embodiment of a lubricant gun according to this invention;

FIG. 3 is a fragmentary sectional view of the first preferred embodiment, in which a moving element is disposed proximate to a sensor;

FIG. 4 is a block diagram of a counting circuit used in the first preferred embodiment;

FIGS. 5 and 6 are perspective views illustrating a cycle motion of the moving element relative to the sensor in the first preferred embodiment;

FIG. 7 is a fragmentary sectional view of the first preferred embodiment, in which the moving element is distal from the sensor;

FIG. 8 is a fragmentary sectional view of a second preferred embodiment of a lubricant gun according to this invention;

FIGS. 9 and 10 are perspective views illustrating a cycle motion of the moving element relative to the sensor in the second preferred embodiment; and

FIG. 11 is a fragmentary sectional view of a third preferred embodiment of a lubricant gun according to this invention.

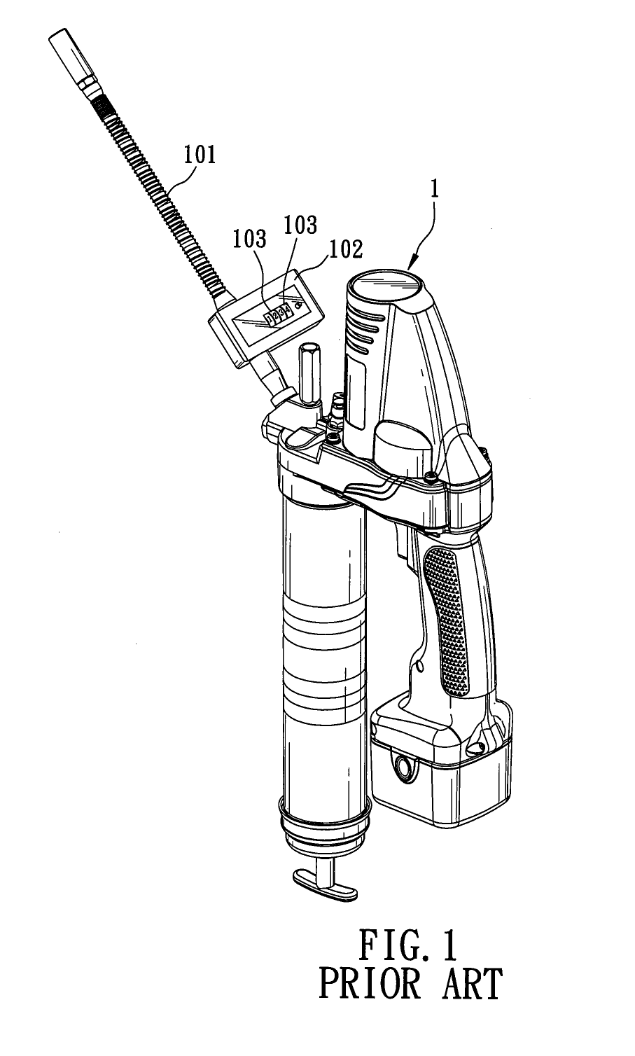

### DETAILED DESCRIPTION OF THE PREFERRED EMBODIMENTS

Before the present invention is described in greater detail, it should be noted that like elements are denoted by the same reference numerals throughout the disclosure.

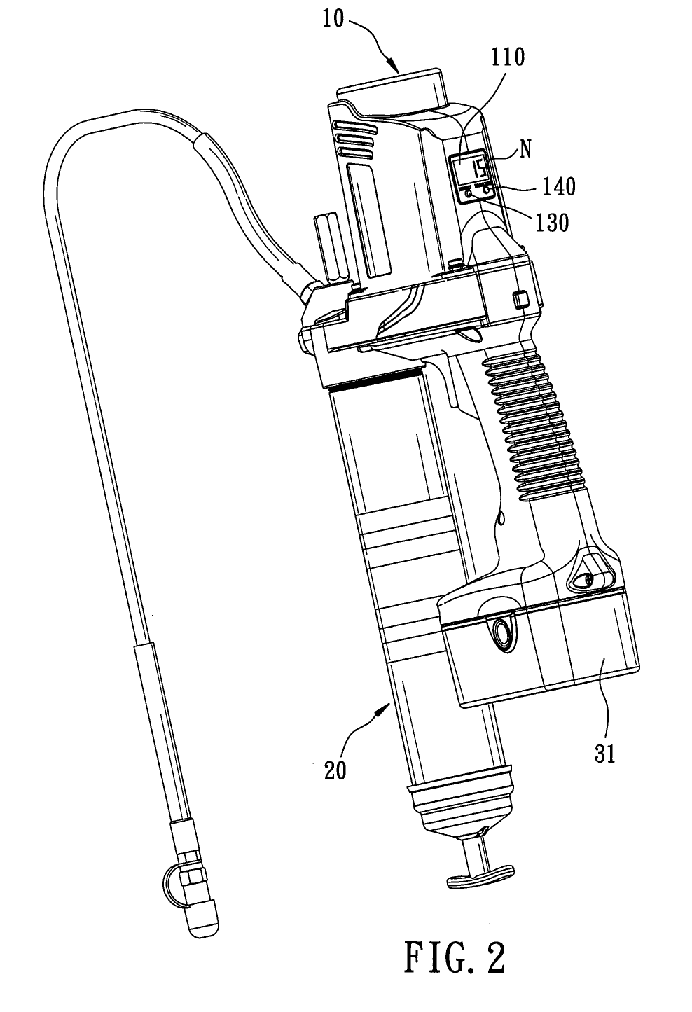

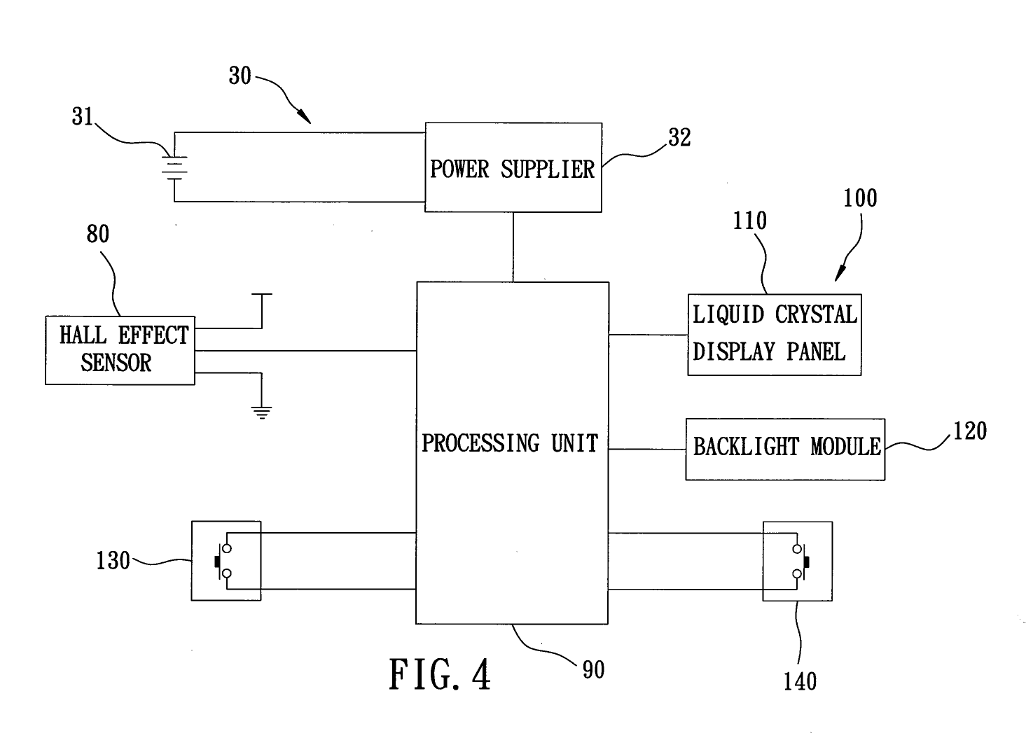

Referring to FIGS. 2, 3, and 4, the first preferred embodiment of a lubricant gun according to this invention is shown to include a housing 10, a lubricant reservoir 20, a power supply unit 30, a motor 40, a plunger 50, a power transmission unit 60, a moving element 70, a sensor 80, a processing unit 90, and a display unit 100.

The housing 10 includes a discharge spout 11, and a longitudinal slide channel 12 fluidly communicating with the discharge spout 11.

The lubricant reservoir 20 is connected to the housing 10 and provides a supply of lubricant into the longitudinal slide channel 12.

The power supply unit 30 includes a battery 31 and a power supplier 32 connected electrically to the battery 31.

The motor 40 is mounted within the housing 10, and is connected electrically to the battery 31.

The plunger 50 is disposed in the longitudinal slide channel 12 to perform reciprocating movements, and has a pushing end 51 extendable to the discharge spout 11, and a connecting end 52 opposite to the pushing end 51.

The power transmission unit 60 is mounted between the motor 40 and the connecting end 52 of the plunger 50, and is driven by the motor 40 to actuate the plunger 50 to perform the reciprocating movements. The power transmission unit 60 includes a planet gear set 61 connected to the motor 40, and a final driver 62 mounted between the planet gear set 61 and the connecting end 52 of the plunger 50.

The planet gear set 61 includes a first sun gear 611 mounted on an output shaft of the motor 40, an annular gear 612 mounted within the housing 10, a first planet gear carrier 613, a plurality of first planet gears 614 mounted on the first planet gear carrier 613 and meshing with the first sun gear 611 and the annular gear 612 simultaneously, a second sun gear 615 mounted under the first planet gear carrier 613, a second planet gear carrier 616 pivotally mounted within the housing 10, a plurality of second planet gears 617 mounted on the second planet gear carrier 616 and meshing with the second sun gear 615 and the annular gear 612, and a driving gear 618 mounted under the second planet gear carrier 616.

The final driver 62 includes a positioning shaft 621 mounted within the housing 10, a gear member 622 surrounding the positioning shaft 612 and meshing with the driving gear 618, a needle bearing 623 mounted between the positioning shaft 621 and the gear member 622, and a crank 624 interconnecting the connecting end 52 of the plunger 50 and the gear member 622. The crank 624 has a first portion 625 connected pivotally to the connecting end 52 of the plunger 50, and a second portion 626 opposite to the first portion 625 and connected eccentrically and pivotally to the gear member 622. The rotation of the motor 40 is transmitted through the planet gear set 61 to rotate the gear member 622 relative to the positioning shaft 621 at a reduced speed so that the crank 624 can be activated eccentrically to drive the reciprocating movements of the plunger 50.

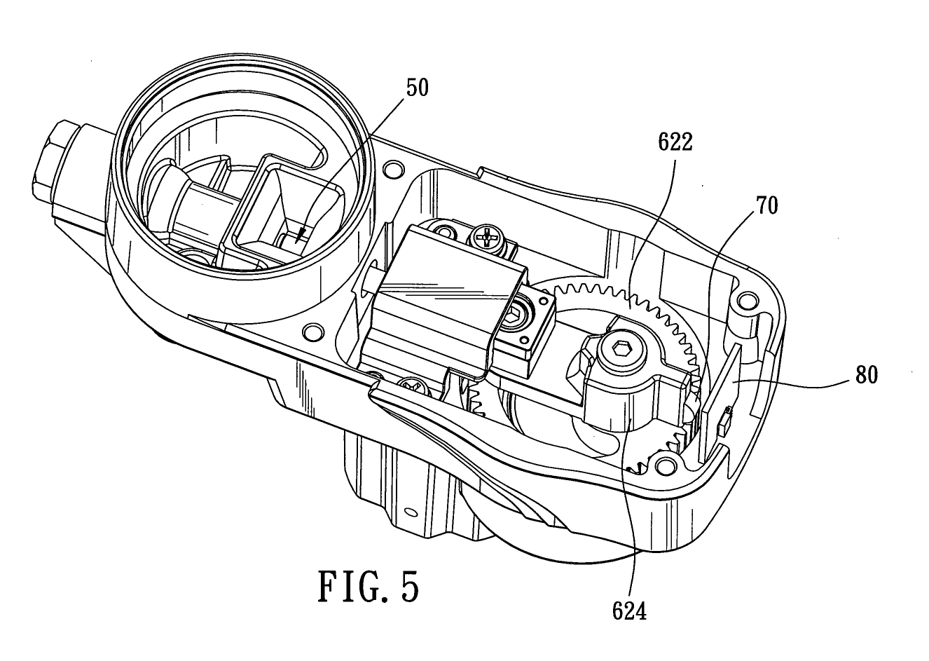

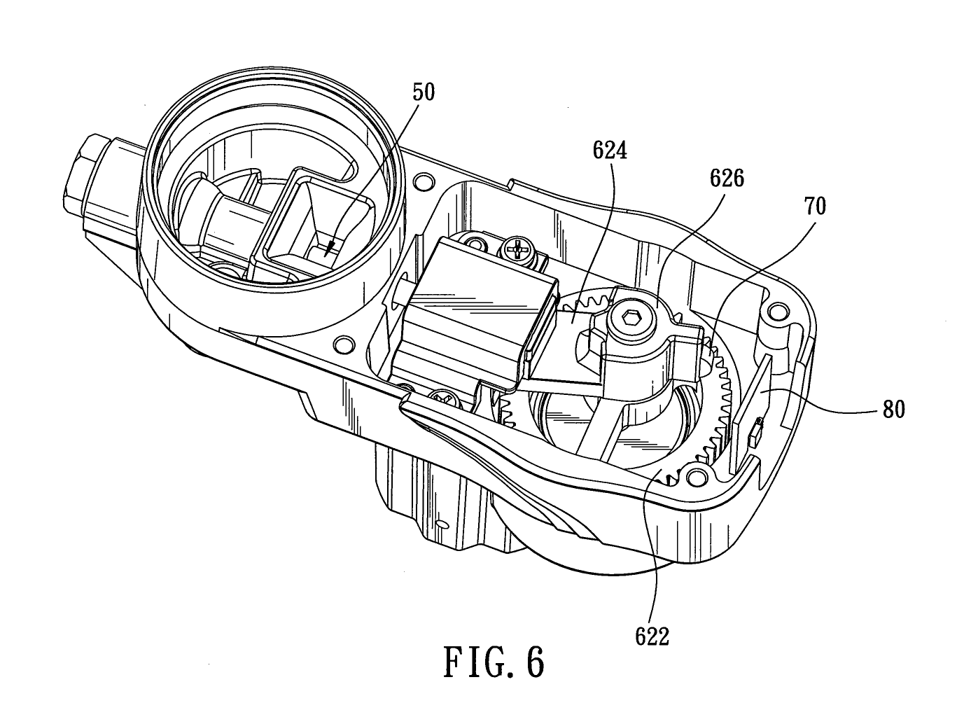

Referring to FIGS. 5 and 6, the moving element 70 is movable along with the crank 624 and the plunger 50 to per form a cycle motion. In this preferred embodiment, the moving element 70 is connected to the second portion 626 of the crank 624, and is a permanent magnet.

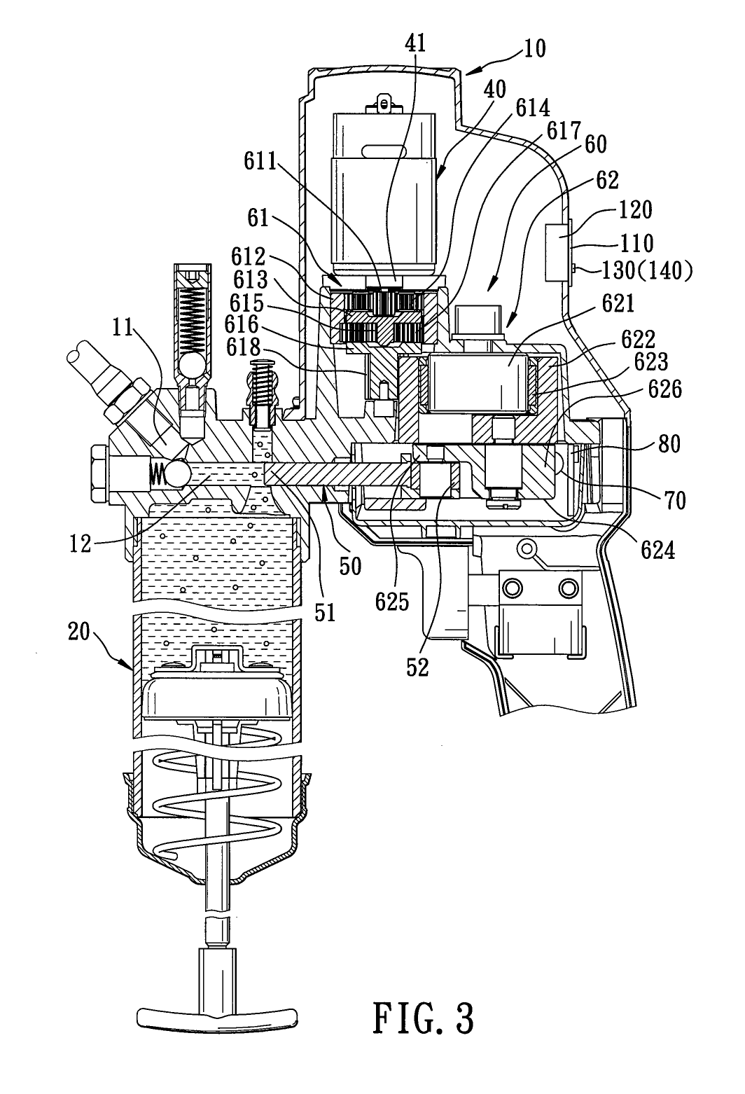

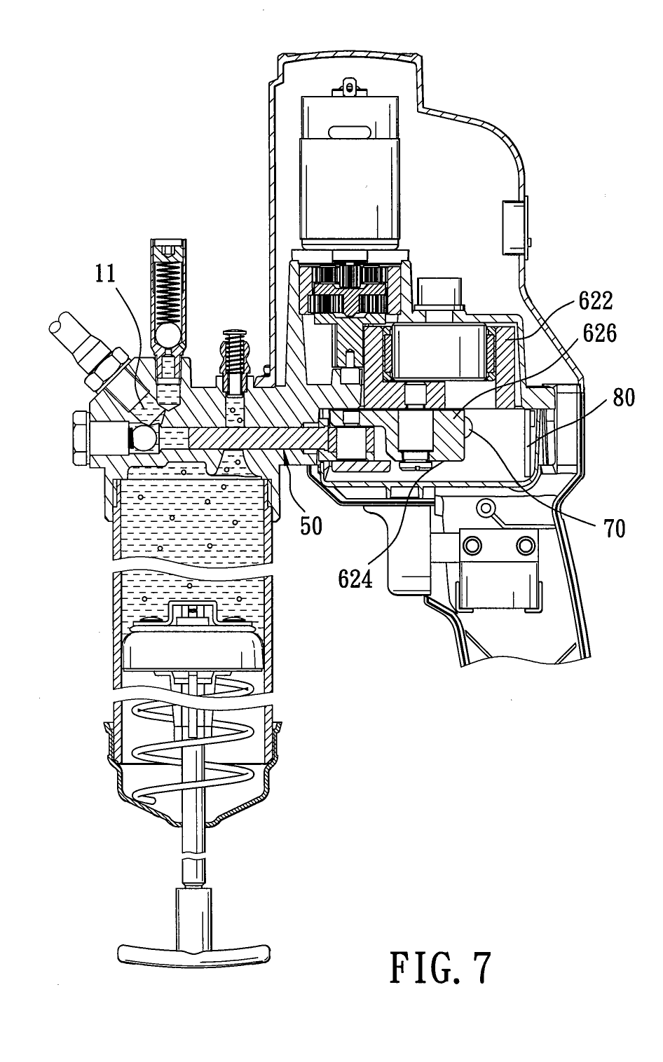

The sensor 80 is mounted inside the housing 10 proximate to a moving path of the moving element 70 to detect the moving element 70 whenever the moving element 70 moves past the sensor 80 during the reciprocating movement between a first position in which the moving element 70 is close to the sensor 80 (best shown in FIGS. 3 and 5) and a second position in which the moving element 70 is away from the sensor 80 (best shown in FIG. 7), and to generate a signal representative of a number of the cycle motions performed by the moving element 70. In this preferred embodiment, the sensor 80 is disposed proximate to the crank 624, and is a Hall effect sensor.

The processing unit 90 is mounted within the housing 10, and is connected electrically to the sensor 80 to produce information according to the signal generated by the sensor 80. The processing unit 90 is also connected electrically to the power supplier 32 and the display unit 100.

The display unit 100 is mounted on the housing 10 to display the information produced by the processing unit 90. The display unit 100 includes a liquid crystal display panel 110 for displaying a counting number (N) thereon, a backlight module 120, a switch 140 for controlling the backlight module 120, and a reset button 130 for resetting the information, i.e., the counting number (N), produced by the processing unit 90.

Referring to FIGS. 3, 5, 6, and 7, when the second portion 626 of the crank 624 is rotated eccentrically in a cycle to perform a reciprocating movement of the plunger 50 to discharge the lubricant via the discharge spout 11, the moving element 70 moves past the sensor 80 to generate a counting signal which is transmitted to the processing unit 90.

In this preferred embodiment, the counting number (N) displayed on the liquid crystal display panel 110 is representative of a product of the number of the cycle motions of the crank 624 per minute and a reference factor. For example, it is assumed that the rotating speed of the crank 624 is 150 rpm. Therefore, the sensor 80 generates 150 counting signals per minute. If the reference factor is 1/10, the counting number (N) displayed on the liquid crystal display panel 110 is 15. Furthermore, according to the counting number (N), the amount of the lubricant discharged per minute can be measured.

Moreover, referring once again to FIG. 2, the user can calculate the amount of the lubricant discharged from the lubricant gun to a lubricant system of a machine or a car according to the counting number (N) displayed on the liquid crystal display panel 110, and can compare the amount of the discharged lubricant to the previous recorded value so as to check if the lubricant system in the machine or the car operates normally. For example, if the lubricant system is not full when the amount of the discharged lubricant reaches the previous recorded value, the lubricant system may have a leaking problem. On the other hand, if the amount of the discharged lubricant does not reach the previous recorded value when filling the lubricant system, the lubricant system may have a blocking problem.

In view of the aforesaid, since the moving element 70 is sensed by the sensor 80 in a non-contact manner (i.e., via a magnetic force), and since the moving element 70, the sensor 80, the processing unit 90, and the display unit 100 are not mounted in the discharge spout 11, the abrasion problem encountered in the prior art can be avoided.

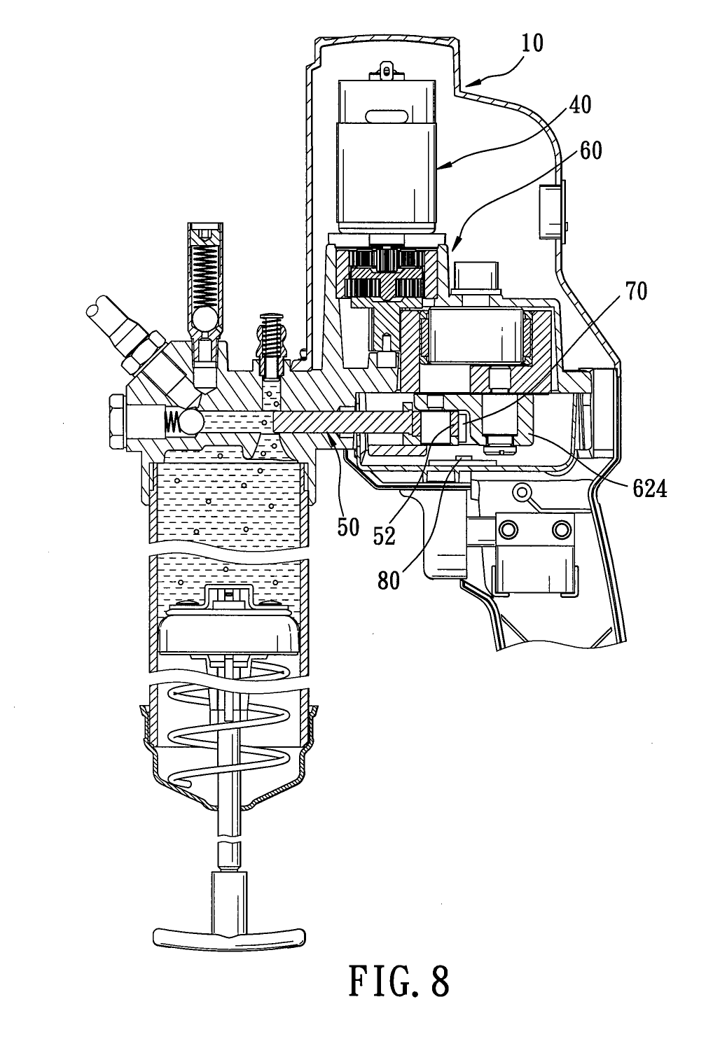

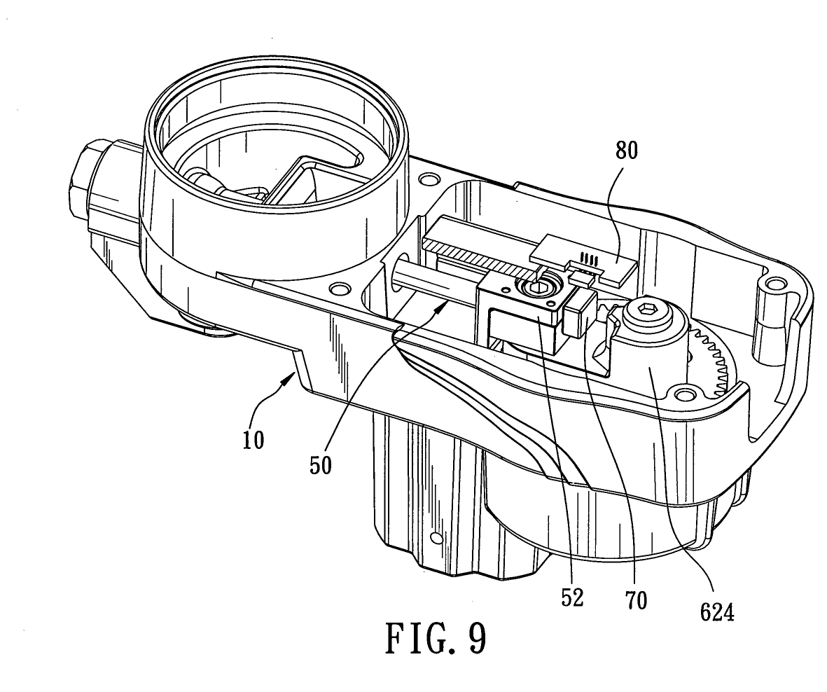

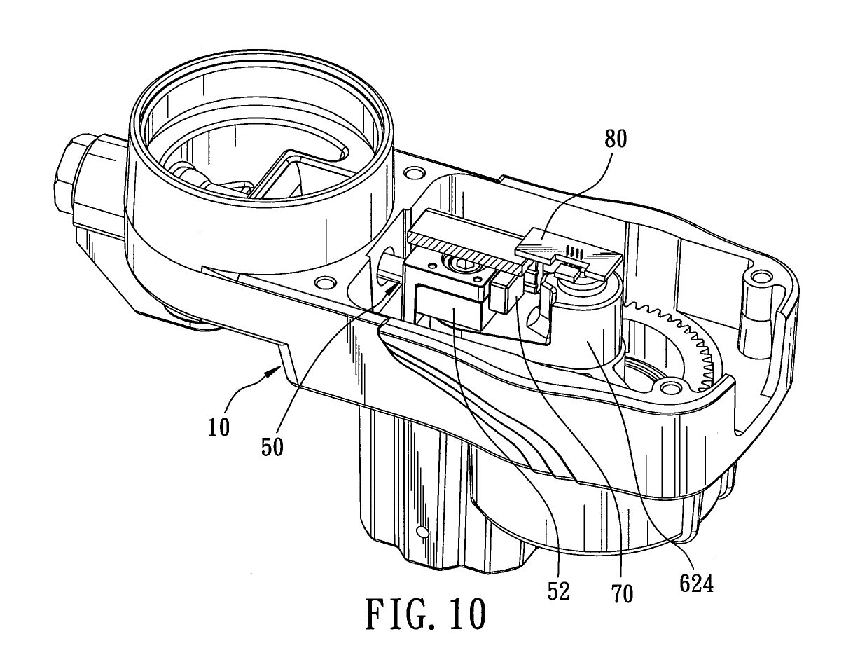

Referring to FIGS. 8, 9, and 10, the second preferred embodiment of a lubricant gun according to this invention is shown to be similar to the first preferred embodiment except that the moving element 70 is attached to the connecting end 52 of the plunger 50, and that the sensor 80 is disposed proximate to the connecting end 52. The sensor 80 detects the moving element 70 whenever the moving element 70 moves past the sensor 80 during the reciprocating movement between a first position in which the moving element 70 is close to the sensor 80 (best shown in FIG. 9) and a second position in which the moving element 70 is away from the sensor 80 (best shown in FIG. 10), and generates a signal representative of the number of cycle motions performed by the moving element 70.

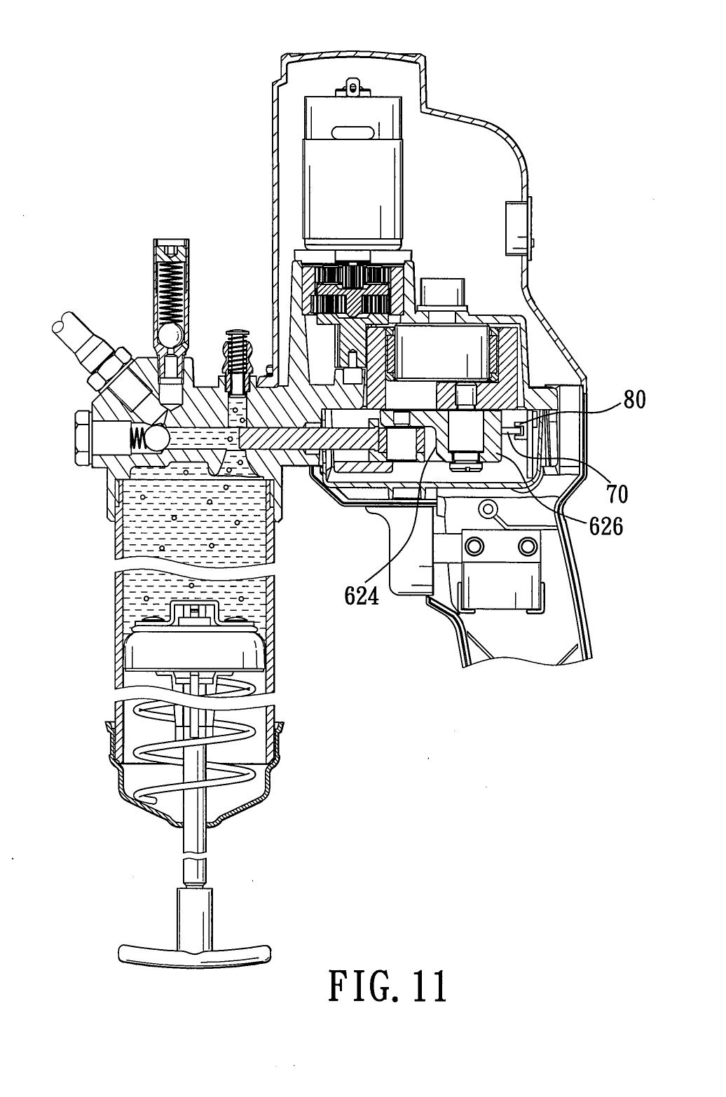

Referring to FIG. 11, the third preferred embodiment of a lubricant gun according to this invention is shown to be similar to the first preferred embodiment except that the moving member 70 is a photo interrupter and the sensor 80 is a photoelectric sensor, i.e., a light emitter-receiver pair.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A lubricant gun comprising:
a housing including a discharge spout, and a longitudinal slide channel fluidly communicating with said discharge spout;
a motor mounted within said housing;
a plunger disposed in said longitudinal slide channel to perform reciprocating movements, and having a pushing end extendable to said discharge spout;
a power transmission unit driven by said motor to actuate said plunger;
a moving element movable along with said power transmission unit and said plunger to perform a cycle motion;
a sensor mounted inside said housing proximate to a moving path of said moving element to detect said moving element whenever said moving element moves past said sensor, and to generate a signal representative of a number of the cycle motions performed by said moving element;
a processing unit connected to said sensor to produce information according to the signal generated by said sensor; and
a display unit mounted on said housing and connected to said processing unit to display the information produced by said processing unit.

2. The lubricant gun as claimed in claim 1, wherein said power transmission unit includes a crank connected to said plunger.

3. The lubricant gun as claimed in claim 2, wherein said moving element is connected to said crank, said sensor being disposed proximate to said crank.

4. The lubricant gun as claimed in claim 2, wherein said plunger further has a connecting end opposite to said pushing end and connected to said crank, said moving element being attached to said connecting end, said sensor being disposed proximate to said connecting end.

5. The lubricant gun as claimed in claim 2, wherein said moving element is a magnet attached to one of said crank and said plunger, and said sensor is a Hall effect sensor.

6. The lubricant gun as claimed in claim 1, wherein said moving member is a photo interrupter, and said sensor is a photoelectric sensor.

7. The lubricant gun as claimed in claim 1, wherein said display unit includes a liquid crystal display panel.

8. The lubricant gun as claimed in claim 7, wherein said display unit further includes a backlight module, and a switch for controlling said backlight module.

9. The lubricant gun as claimed in claim 1, wherein said display unit includes a reset button for resetting the information produced by said processing unit.

10. The lubricant gun as claimed in claim 1, further comprising a lubricant reservoir connected to said housing and providing a supply of lubricant into said longitudinal slide channel.
